(19) United States
(12) Patent Application Publication
(10) Pub. No.: US 2015/0202531 A1
(43) Pub. Date: Jul. 23, 2015

(54) Wecovery- MMORPG

(71) Applicant: Danielle Marie Staley, Cannon Falls, MN (US)

(72) Inventor: Danielle Marie Staley, Cannon Falls, MN (US)

(21) Appl. No.: 14/160,544

(22) Filed: Jan. 21, 2014

(51) Int. Cl. A63F 13/35; G09B 5/06; A63F 13/87

(52) U.S. Cl. CPC A63F 13/35; A63F 13/87; G09B 5/06

(57) ABSTRACT

Wecovery is a massive multiplayer role-playing game for addiction recovery online. It is virtual reality rehabilitation for those suffering from problems with addiction. It has a social networking site attached. Wecovery is a way for addicts to receive treatment when they may not be able to do so otherwise. This is a novel approach because it changes the way that addictions are treated now. This allows patients to receive treatment anywhere at any time for their addiction. This is all done online through a videogame. The software or game will be a city in which clients can navigate through the different groups, videos, role-playing, meetings, and other activities that will help with the patient's goal of recovery. Many people would benefit from rehabilitation online in a game rather than traditional addiction treatment. It changes the way addiction is treated, rather than attending treatment in person this is all online.

### BACKGROUND OF THE INVENTION

The chemical dependency treatment field has worked under the premise of people going to specific physical locations to obtain treatment. People seeking treatment for addiction have to be assessed by a licensed counselor to be able to get into a treatment program. Only a handful of treatment centers are even considering the possibility of opening that up to helping people online and currently they don't offer the treatment online. There has been a tradition in chemical dependency that people need to be taken out of the environment and go to an impatient treatment facility. We understand that for some this may not be a possibility. Often people are unable to attend treatment due to lack of transportation, unable to leave their lives to attend treatment. It is also evident in the treatment field that those seeking addiction are younger than ever before. We are trying to address the needs of those individuals who are unable to attend traditional treatment programs. We are making treatment accessible to more people through the internet. Those needing treatment and counseling will be able to connect to those resources through our online treatment option.

### BRIEF SUMMARY

Wecovery is a virtual reality treatment center within a massive multiplayer role playing game. We provide people with the option of meeting with counselors, attend group sessions, learn life skills, and connect with other addicts in recovery. This will not only be a role-playing game but players will have the ability to connect through our social networking site. This solves many of the barriers facing those who are unable to receive traditional treatment and it reaches the younger generations that are enmeshed in the videogame lifestyle. Ultimately this is a program for anyone who is unable to go the traditional route of treatment. We bring the treatment services to their home through their computer. The best part is that this treatment program can reach more than traditional treatment programs.

### DETAILED DESCRIPTION

Wecovery will be a massive multi-player role playing game. It will be a computer program hosted by a cloud server to reach those seeking treatment online. Patrons will be able to log-on, create their player and start playing. These players will be able to attend specific treatment groups in which they can learn the specific skills they need to treat their addiction. We will be using many of the current treatment literature to develop groups that will be ever-changing based upon the evidence based practices in the field of chemical dependency. Players will also be able to connect to holistic classes and services that can help them attain an overall wellness that will help them in their recovery from addiction. There will be seminars/groups on life skills, yoga, overall well-being, financial planning, communication, and relationships. These offerings will expand with the game and player needs. Players will be able to attend meetings with various groups associated with recovery. Players will also have the option of meeting one on one with counselors to receive the specific assistance for their recovery needs. Players will be able to receive an individualized treatment plan for specific activities and groups they should attend. Players will also be able to participate in role-playing activities that will help them practice positive outcomes for life experiences. They will be able to connect to other people suffering from addiction through a social networking platform that will allow them to communicate to one another to form the connections important to furthered recovery.

1. Although we are using the massive multiplayer role playing game platform we are doing so with the treatment of addictions in mind. Using this game for treatment and designing it in such a way that those seeking treatment in a nontraditional way, online, can receive assistance sets us apart. The use of this game to treat various addictions through counseling, group therapy, holistic seminars, classes and practice scenarios is unique in the addiction field as well as in video game design. We are also attaching a social networking cite geared specifically for those in recovery for addictions. This makes this particular software unique.
